(19) United States
(12) Patent Application Publication
(10) Pub. No.: US 2003/0136235 A1
(43) Pub. Date: Jul. 24, 2003

(54) Clamping tool, in particular locking pliers

(76) Inventor: Jean-Pierre Flavigny, Sainte Pe sur Nivelle (FR)

Correspondence Address: WENDEROTH, LIND & PONACK, L.L.P., 2033 K STREET N. W., SUITE 800, WASHINGTON, DC, 20006-1021, US

(21) Appl. No.: 10/240,669

(22) PCT Filed: Apr. 6, 2001
(86) PCT No.: PCT/FR01/01059

(30) Foreign Application Priority Data
Apr. 7, 2000 (FR) 00/04518

(51) Int. Cl. B25B 7/12

(52) U.S. Cl. 81/355

(57) ABSTRACT

The invention concerns a tool comprising: a fixed part (2) extending along a longitudinal direction and comprising a fixed rigid subassembly (3) rigidly linked at the front to a fixed jaw (4) and linked at the rear to a first handle (5) by a linkage which is rigid at least for actuating the opening of the jaws; a mobile part (6) comprising a rigid mobile assembly (7) articulated by a pivot (8) on the fixed subassembly (3), and a mobile jaw (10) linked to the front part of said mobile subassembly; means (5, 9) for opening the jaws (4, 10); a locking member (29) adapted, in each relative position of the two jaws, to prevent the jaws from being spaced apart; means (31, 33, 37) for releasing the locking member capable of being actuated by the operator; a pre-clamping spring (18) acting between the fixed subassembly (3) of the fixed part (2) and the mobile part (6); and a mechanism (12) for applying a clamping force acting between the mobile jaw (10) and the mobile subassembly (7).

The present invention relates to a clamping tool, particularly locking pliers.

The object of the invention is to provide a clamping tool which, in a particular ergonomic way, makes it possible to obtain pre-clamping of an object, freeing the hands of the user so as to allow the latter to adjust the position of the object before clamping this object firmly and stably. This is particularly advantageous when the object in question is made up of at least two superposed parts which need, for example, to be welded together.

To this end, the subject of the invention is a clamping tool, particularly locking pliers, characterized in that it comprises:

a fixed part extending in a longitudinal direction and comprising a fixed rigid subassembly connected rigidly at the front to a fixed jaw and connected at the rear to a first handle by a connection which is rigid at least for causing the jaws to open;

a moving part comprising a moving rigid subassembly articulated by a pivot to the fixed subassembly, and a moving jaw connected to the front part of this moving subassembly;

means for opening the jaws;

a locking member designed to, in each relative position of the two jaws, prevent the jaws from being parted;

means for releasing the locking member and which can be actuated by the operator;

a pre-clamping spring acting between the fixed subassembly of the fixed part and the moving part; and

a mechanism for applying a clamping force acting between the moving jaw and the moving subassembly.

The clamping tool according to the invention may have one or more of the features described in claims 2 to 20 taken in isolation or in any technically feasible combination thereof.

U.S. Pat. No. 2,997,903 and U.S. Pat. No. 3,354,759 describe locking pliers in which a spring urges the jaws towards each other. However, in these known tools, the aforementioned spring does not make it possible to obtain true pre-clamping of the object, that is to say to allow the tool to hold onto this object of its own accord.

An exemplary embodiment will now be described with reference to the appended drawings in which:

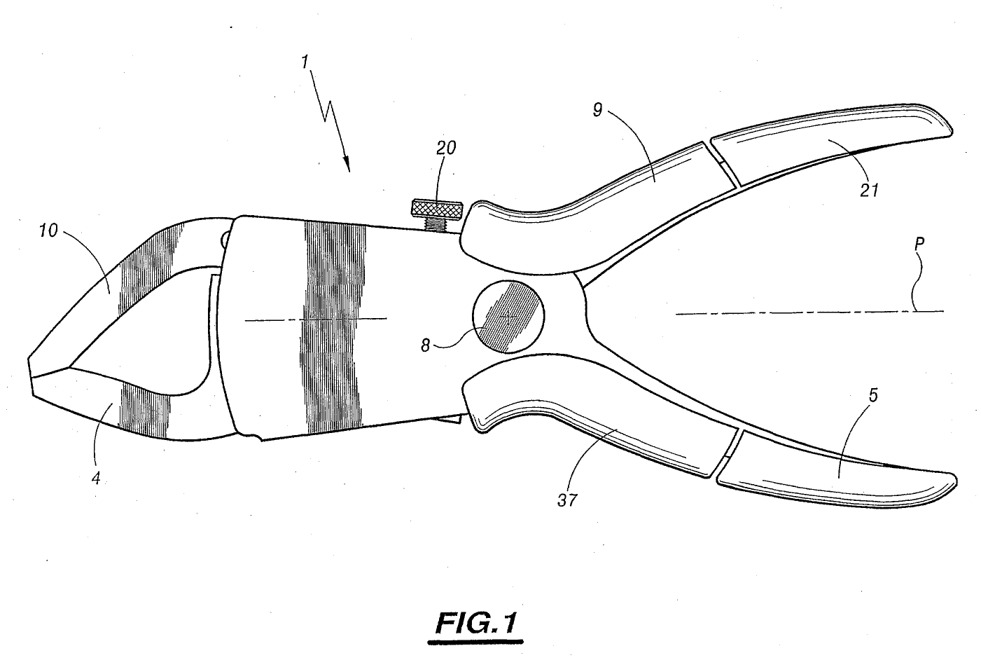

FIG. 1 is an external view of locking pliers according to the invention;

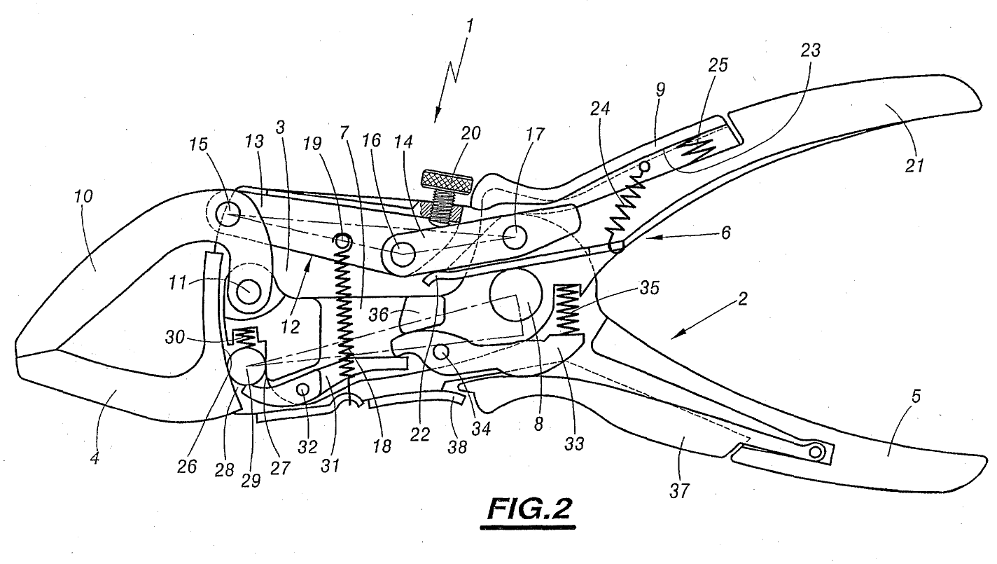

FIG. 2 is a view showing the various components of these locking pliers, the tool being in a rest position;

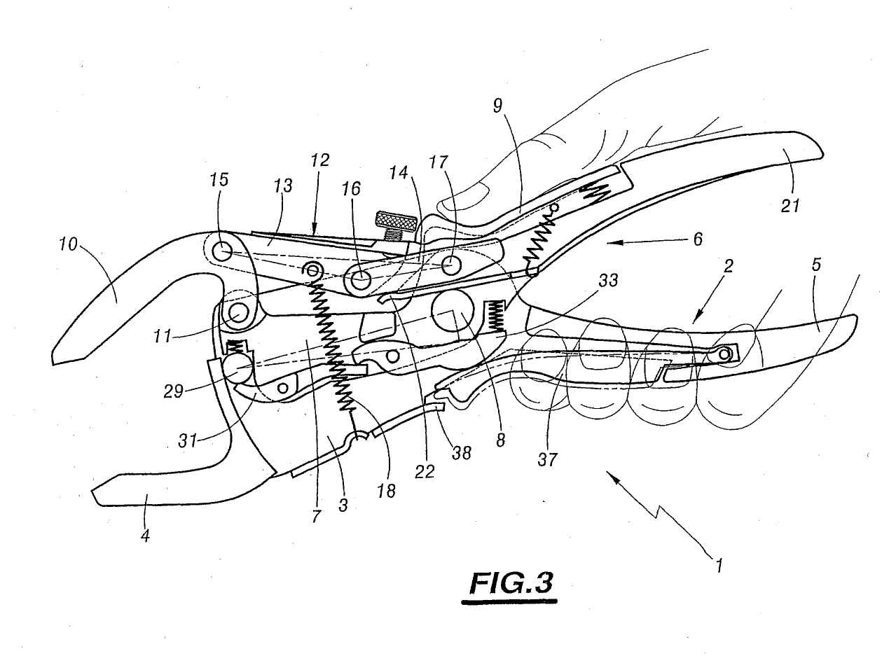

FIG. 3 is a view similar to FIG. 2, depicting the opening of the jaws;

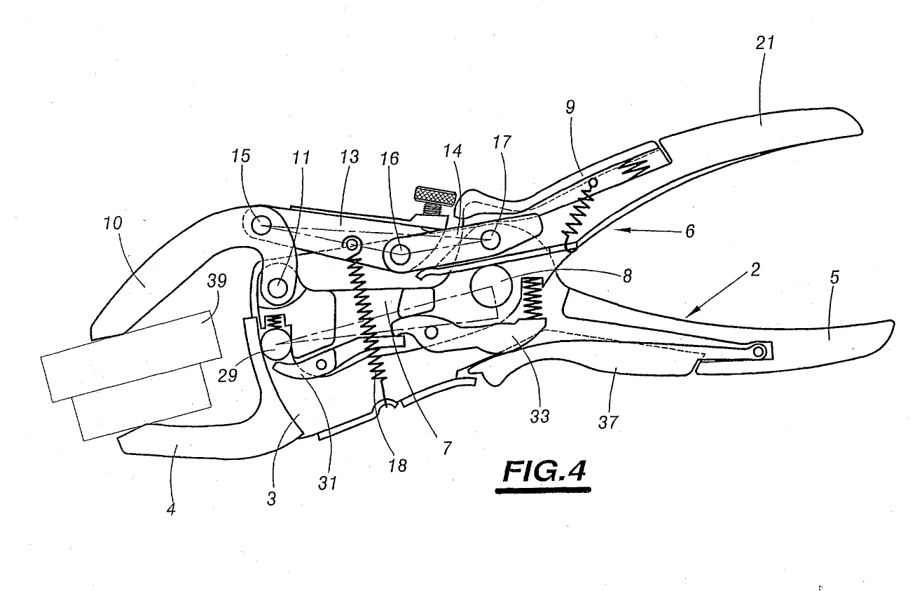

FIG. 4 is a view similar to FIG. 2 depicting the tool in the position of pre-clamping an object;

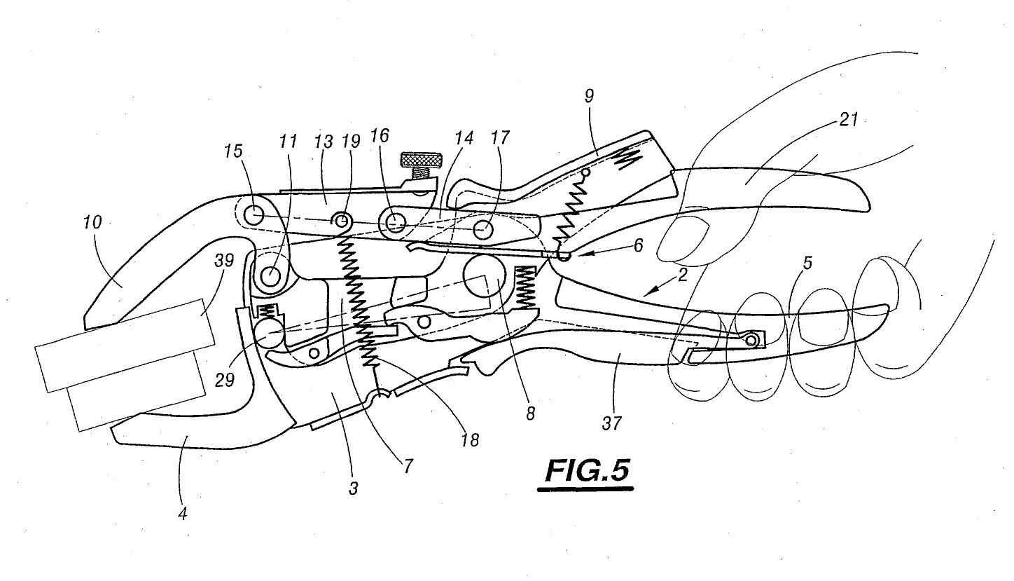

FIG. 5 is a view similar to FIG. 2, depicting the phase of clamping the object; and

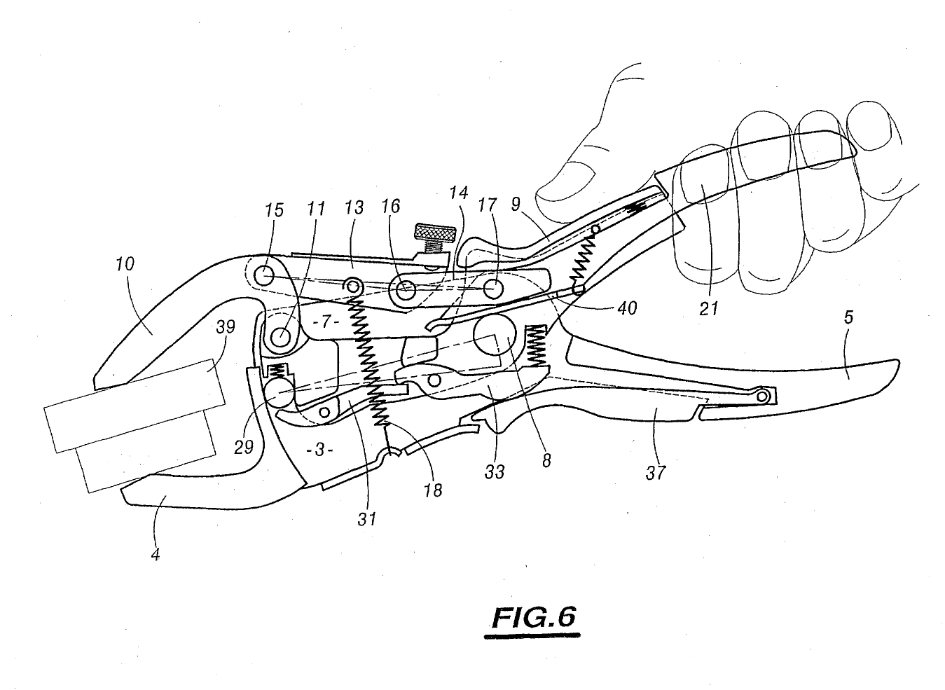

FIG. 6 is a view similar to FIG. 2 depicting the phase of releasing the toggle.

The locking pliers 1 depicted in the drawings, assumed to be contained in a vertical overall plane, consists essentially of the following four parts:

(1) A fixed part 2 which is rigid, comprising a rigid mounting plate 3 which is extended forward by a fixed jaw 4 and backward by a fixed handle 5. In the position depicted, the jaw 4 is the lower jaw of the tool, and the handle 5 is the lower handle.

(2) A moving part 6 which itself comprises:

a rocker 7 articulated more or less mid-way along its length to the rear region of the mounting plate 3 by means of a first pivot or main pivot 8. The part of the rocker which lies behind the pivot 8 forms a lever 9 for opening the-jaws;

a moving jaw 10 in the overall form of a C, open at the bottom, that is to say toward the jaw 4. This jaw 10 has its lower rear end articulated to the front end of the rocker 7 by means of a second pivot 11; and

a toggle 12 made up of two links, a front link 13 and a rear link 14. The front end of the link 13 is articulated to an upper rear point of the jaw 10 by means of a third pivot 15. The rear end of the link 13 and the front end of the link 14 are articulated to one another by means of a fourth pivot 16 which constitutes the intermediate point of the toggle. The rear end of the link 14 is articulated to the rocker 7, above the pivot 8, by means of a fifth pivot 17.

In addition, a mechanical spring 18 is stretched, more or less vertically, between an intermediate point 19 on the link 13, situated forward of the pivot 16, and a lower location on the mounting plate. This spring constantly urges the toggle toward the downward broken position depicted, the break angle of which is limited in an adjustable way by a cup point screw 20 with a knurled head screwed downward into the rear end of the link 13, behind the pivot 16.

(3) A toggle passage lever 21. This lever is articulated in its front part to the pivot 17 and continues forward in the form of an actuating nose 22. Behind the pivot 17, the lever 21 is housed over a certain length in a lower recess 23 of the lever 9, then continues backward beyond the rear end of the latter. The lever 9 and the continuation of the lever 21 together have a shape which is more or less symmetric with the shape of the lower handle 5. Thus, the tool as a whole has an overall contour (FIG. 1) which is roughly symmetric with respect to a median plane P passing through the pivot 8, and an overall arrangement of the “clothes peg” type, that is to say not intersecting, with respect to the main pivot 8.

A helical tension spring 24 stretched between the lever 9 and 21 urges the intermediate part of the lever 21 into the recess 23, while a helical compression spring 25 is arranged between the bottom of this recess and the upper surface of the lever 21.

(4) A disablable one-way brake device. This device comprises:

a rear surface 26 of the fixed jaw 4, centered on the pivot 8;

a front surface 27 of the rocker 7, which, with the surface 26, forms a wedge-shape space 28 narrowing downward;

a locking ball 29 arranged in the space 28 is urged downward by a helical compression spring 30, which presses into a housing provided at the front of the rocker 7, under the pivot 11;

a first linkage 31 for disabling the brake. This linkage, articulated by an intermediate point 32 to the rocker 7, has a front nose designed to collaborate with the ball 29;

a second linkage 33 for disabling the brake. This linkage, articulated by an intermediate point 34 to the rocker 7, is urged in the clockwise direction by a spring 35 until its front end is in abutment against a projection 36 of the rocker; and

a trigger 37 for disabling the brake, this trigger being articulated by its rear end to the handle 5 and its front end, retained by a tab 38 secured to the mounting plate 3, collaborating with the rear part of the linkage 33.

At rest (FIG. 2), the spring 18 keeps the toggle broken and, by urging the moving part 6 in the counterclockwise direction about the pivot 8, keeps the jaws 4 and 10 in mutual contact.

Under the action of the spring 30, the ball 29 is wedged between the surfaces 26 and 27, and this prevents any opening of the jaws.

The first phase in the use of the locking pliers is depicted in FIG. 3. The operator takes hold of the tool like he would pliers, placing his index finger on the trigger 37 and his thumb on the lever 9.

First of all, the trigger is depressed against the action of the spring 35. By means of the two linkages 33 and 31, these lift the ball 29 against the action of the spring 30 and thus eliminates the wedging action.

In the same action, with the trigger still depressed, the operator presses on the lever 9. This causes the entirety of the moving part 6, namely the rocker 7, the jaw 10 and the toggle 12, to rock as one about the pivot 8, against the action of the spring 18. As a result, the jaws open.

Next (FIG. 4), an object 39 that is to be clamped, typically consisting of two superposed elements as depicted, is placed between the two jaws, and the operator releases his action on the lever 9. The spring 18 then causes the jaws to close again onto the object 39, and to pre-clamp the latter with only the force of the spring 18. The trigger 37 can then be released and the locking pliers remain in place on the object 39 of their own accord.

The operator thus has his hands free and can use both hands to adjust the relative position of the two elements of the object 39.

As will be understood, the stiffness of the spring 18 is chosen so that the spring is strong enough to hold the locking pliers in place on the object 39 merely under its own action, but weak enough to allow this object to be shifted between the jaws.

Next (FIG. 5), the operator takes hold of the lever 21 and the handle 5, and moves them closer together, something which requires him merely to move his hand back slightly with respect to the position for opening in FIG. 3. The front nose 22 of this lever, pushing the front region of the link 14 upward, straightens the toggle 12 again and causes it to pass through its neutral point to a small extent. Appropriate stops (not depicted) provided on the two links limit this movement slightly beyond the neutral point.

It may be noted this actuation of the toggle is allowed by virtue of the jaw 10 being articulated at 11 to the rocker 7. As an alternative, the elements 7 and 10 could be produced as a single piece and the articulation 11 could be replaced by an elastically flexible link between these two elements.

Finally (FIG. 6), to release the object 39, the operator grasps the lever 21 with four fingers of one hand and uses his thumb to press the lever 9. A projection 40 of the lever 21, situated behind the pivot 17, then acts on the rear end of the link 14, which lies behind the pivot 17, and this causes this link to rock in the counterclockwise direction and therefore causes the toggle to straighten out and then break. The locking pliers thus return to their pre-clamping position of FIG. 4.

To release the object 39, the operator once again presses the trigger 37, which disables the brake 29, and opens the jaws by moving the lever 9 closer to the handle 5 as described above with reference to FIG. 3. Finally, releasing the lever 9 and the handle 5 returns the tool to its position of rest of FIG. 2, under the action of the spring 18.

It may be noted that since the toggle 12 is stretched between two parts 7 and 10 of the moving part 6, the sudden relaxation of this toggle as it is released causes no violent reaction in the operator's hand. The locking pliers are therefore very smooth to handle and give a high level of safety.

In addition, for the same reason, the pre-clamping movement caused by the spring 18 causes the entire moving part 6 to rock as one about the axis 8, as described above. In consequence, the geometry of the toggle 12, which defines the path of application of the clamping force, is independent of the path of application of the pre-clamping force, which path is defined by the two anchor points of the spring 18. In other words, the adjustment of the toggle, performed in advance using the screw 20, defines a predetermined clamping force which remains constant regardless of the thickness of the object 39 that is to be grasped.

Of course, as an alternative, at least one of the jaws may, at its free end, have an articulated moving jaw as is known in the art.

1. A clamping tool, particularly locking pliers, characterized in that it comprises:
a fixed part (2) extending in a longitudinal direction and comprising a fixed rigid subassembly (3) connected rigidly at the front to a fixed jaw (4) and connected at the rear to a first handle (5) by a connection which is rigid at least for causing the jaws to open;
a moving part (6) comprising a moving rigid subassembly (7) articulated by a pivot (8) to the fixed subassembly (3), and a moving jaw (10) connected to the front part of this moving subassembly;
means (5, 9) for opening the jaws (4, 10);
a locking member (29) designed to, in each relative position of the two jaws, prevent the jaws from being parted;
means (31, 33, 37) for releasing the locking member and which can be actuated by the operator;
a pre-clamping spring (18) acting between the fixed subassembly (3) of the fixed part (2) and the moving part (6); and
a mechanism (12) for applying a clamping force acting between the moving jaw (10) and the moving subassembly (7).

2. The tool as claimed in claim 1, characterized in that the locking member (29) is normally active for each relative position of the two jaws (4, 10).

3. The tool as claimed in one of the preceding claims, characterized in that the locking member (29) is a one-way locking member which allows the two jaws (4, 10) to be moved closer together.

4. The tool as claimed in one of the preceding claims, characterized in that:
means (5, 9) for opening the jaws comprise a lever (9) connected to the rear part of the moving subassembly by a connection which is rigid at least for causing the jaws-to open;
said release means (31, 33, 37) can be actuated by the hand holding the first handle (5) and the lever (9) for opening the jaws;
said mechanism (12) for applying a clamping force is designed to be activated by the operator by means of an activating lever (21) when the jaws are in any pre-clamping relative position, the locking member (29) being active; and
the arrangement is such that the action of one hand tending to apply a force to move the first handle (5) toward the lever (9) for opening the jaws roughly perpendicular to the longitudinal direction of the fixed part actuates the release means and then causes the jaws to open, and such that the action of the same hand tending to release said moving-together force allows the pre-clamping spring (18) to exert a pre-clamping force on an object (39) that is to be clamped.

5. The tool as claimed in claim 4, characterized in that the opening lever (9) constitutes a second handle whose movement toward the first handle (5) causes the jaws (4, 10) to open.

6. The tool as claimed in claim 4 or 5, characterized in that the moving jaw (10) is carried by the moving subassembly (7).

7. The tool as claimed in claim 6, characterized in that the mechanism for applying a clamping force is a toggle (12) articulated by one end to the moving jaw (10) and by the other end to the moving subassembly (7).

8. The tool as claimed in claim 7, characterized in that the moving jaw (10) is mounted on the moving subassembly (7) with the possibility of moving with respect to the latter.

9. The tool as claimed in claim 7, characterized in that the moving jaw (10) is articulated to the moving subassembly (7).

10. The tool as claimed in claim 8 or 9, characterized in that the toggle (12) is urged toward a broken position and comprises a member (20) for limiting its break angle.

11. The tool as claimed in claim 10, characterized in that the toggle (12) is urged toward its broken position by the pre-clamping spring (18).

12. The tool as claimed in one of claims 4 to 11, characterized in that the activating lever (21) is articulated on the moving subassembly (7).

13. The tool as claimed in any of the preceding claims, characterized in that the means (31, 33, 37) for releasing the locking member comprise an actuating member (37) provided on the same side as the fixed jaw (4).

14. The tool as claimed in any one of the preceding claims, characterized in that the means (31, 33, 37) for releasing the locking member comprise a trigger (37) arranged in reach of the index finger of the hand holding the first handle (5) and the lever (9) for opening the jaws.

15. The tool as claimed in any one of the preceding claims, characterized in that the means for releasing the locking member comprise a release lever (37) combined with a handle in such a way that the hand holding the first handle (5) and the lever (9) for opening the jaws actuates first of all the release lever (37) and then, in the same movement, causes the first handle (5) and the lever (9) for opening the jaws to move closer together.

16. The tool as claimed in any one of the preceding claims, characterized in that the pivot (8) is located in the rear half of the fixed subassembly (3).

17. The tool as claimed in any one of the preceding claims, characterized in that the locking member (29) is located in the front half of the moving subassembly (7).

18. The tool as claimed in any one of the preceding claims, characterized in that the exterior contour, in a side view, of the tool (1) as a whole is roughly symmetric with respect to a median plane (P) passing through the pivot (8).

19. The tool as claimed in any one of claims 4 to 18, characterized in that the lever (9) for opening the jaws (4, 10) is rigidly secured to the moving subassembly (7).

20. The tool as claimed in any one of the preceding claims, characterized in that the said first handle (5) is rigidly secured to the fixed rigid subassembly (3).
